(19) United States
(12) Patent Application Publication
(10) Pub. No.: US 2024/0267132 A1
(43) Pub. Date: Aug. 8, 2024

(54) AUTO-CONFIGURATION OF USB HOST AND PERIPHERAL ROLES IN AN OPTICAL FRONT-END MODULE

(71) Applicant: SIGNIFY HOLDING B.V., EINDHOVEN (NL)

(72) Inventors: HAIMIN TAO, EINDHOVEN (NL); CHRISTOPH GERARD AUGUST HOELEN, VALKENSWAARD (NL); PIETER JOHANNES STOBBELAAR, EINDHOVEN (NL)

(21) Appl. No.: 18/567,949

(22) PCT Filed: Jun. 3, 2022
(86) PCT No.: PCT/EP2022/065242

§ 371 Date: Dec. 7, 2023

(30) Foreign Application Priority Data
Jun. 8, 2021 (EP) 21178213.1

(51) Int. Cl. H04B 10/80; H04B 10/40

(52) U.S. Cl. CPC H04B 10/806; H04B 10/40

(57) ABSTRACT

An optical front end, OFE, module (200) for use in an optical wirelesscommunication, OWC, system (100), the OFE module (200) comprising: an optical transmitter (210) comprising a light source (211) for transmitting optical signals; an optical receiver (220) comprising a light sensor (221) for receiving optical signals;a control circuit (230) configured to: connect to a USB On-The-Go, OTG, interface (231) comprising a differential data path (232) and an ID signal (233); route signals received on the differential data path (232) to an input of the optical transmitter (210) and signals received on an output of the optical receiver (220) to the differential Q data path (232); control a power-up sequence of the OFE module (200), which defines that the OFE module (200) is initialized by powering up the optical receiver (220) first for detecting an optical test signal within an ID detection period; set the ID signal (233) to GND and latch the ID signal (233) when the optical test signal is received within the ID detection period; set the ID signal (233) to Float and latch the ID signal (233) when no optical test signal is received within the ID detection period.

### FIELD OF THE INVENTION

The invention relates to the field of optical wireless communication, such as Li-Fi communication. More particularly, various methods, apparatus, systems, and computer-readable media are disclosed herein related to the integration of an optical front end in an end device.

### BACKGROUND OF THE INVENTION

To enable more and more electronic devices like laptops, tablets, and smartphones to connect wirelessly to the Internet, wireless communication confronts unprecedented requirements on data rates and link qualities, and such requirements keep on growing year over year, considering the emerging digital revolution related to Internet-of-Things (IoT). Radio frequency technology like Wi-Fi has limited spectrum capacity to embrace this revolution. In the meanwhile, light fidelity (Li-Fi) is drawing more and more attention with its intrinsic security enhancement and capability to support higher data rates over the available bandwidth in visible light, Ultraviolet (UV), and Infrared (IR) spectra. Furthermore, Li-Fi is directional and shielded by light blocking materials, which provides it with the potential to deploy a larger number of access points, as compared to Wi-Fi, in a dense area of users by spatially reusing the same bandwidth. These key advantages over wireless radio frequency communication make Li-Fi a promising secure solution to mitigate the pressure on the crowded radio spectrum for IoT applications and indoor wireless access. Other possible benefits of Li-Fi may include guaranteed bandwidth for a certain user, and the ability to function safely in areas otherwise susceptible to electromagnetic interference. Therefore, Li-Fi is a very promising technology to enable the next generation of immersive connectivity.

In a conventional optical wireless communication (OWC) system, an access point is typically deployed on the ceiling, while the end point with an OWC interface is typically connected or communicatively coupled to an end device as a separate entity, such as a USB dongle. The end device can be a smartphone, a tablet, a computer, a remote controller, a smart TV, a display device, a storage device, a home appliance, or another smart electronic device. In order to boost a wide adoption of Li-Fi communication, it is thus highly desirable that the end point or the optical front end (OFE) for Li-Fi communication can be partially or fully integrated in an end device.

With an OFE module partially or fully integrated in an end device, other attractive application scenarios may be enabled. For example, two end devices may communicate to each other via a direct OWC link, instead of via an AP. Thus, a peer-to-peer OWC system may be constructed.

WO2008121731A1 relates to an optical USB (OUSB) with super-high data rate (e.g. 10 Gbps) optical communication added on top of its current specification so that backward compatibility is achievable.

US2003204652A1 relates to a data transfer control device including a controller which performs operation control of a host function and a peripheral function by transitioning between a plurality of states, the data transfer control device comprising a control register in which a state command corresponding to each state for controlling the controller is set; a signal state detection circuit which detects a signal state of at least one of data lines and power supply line; and a state command decoder which decodes the state command and generates a control signal which controls the signal state of at least one of the data lines and power supply line.

US20170255585A1 relates to a method and system of switching a role of a Universal Serial Bus (USB) On-The-Go (OTG) device and a USB OTG device are provided. According to the method, when the USB OTG device receives a Host Negotiation Protocol (HNP) request sent from a link-partner, an OTG controller of the USB OTG device is reset. The state of an ID-pin detection end which is used by the OTG controller to detect a type of plug of a USB cable is modified to switch the role of the USB OTG device between a host and a peripheral.

### SUMMARY OF THE INVENTION

To facilitate the integration of an OWC interface or an OFE in an end device, it is beneficial to reuse an existing connector or interface in the end device. Since USB interface is widely used in consumer electronic devices, recently work has been done to explore the possibility of transmission and reception of USB signals via a free space optical link, such as a Li-Fi link. Hence, the free space optical link is functioning as a replacement to an USB cable, providing more flexibility to users.

It is proposed to connect an OFE module to the USB interface available inside the end device, such as a smartphone, a tablet, or another electronic device. In a fully integrated version, the OFE module may be permanently connected to the USB interface in the end device.

USB On-The-Go (USB OTG or just OTG) is a specification that allows USB devices, such as tablets or smartphones, to act as a host, allowing other USB devices, such as USB flash drives, digital cameras, mouse or keyboards, to be attached to them. Use of USB OTG allows those devices to switch back and forth between the roles of Host and Device. A mobile phone may read from removable media as the Host but may also act as a Device when it is connected to a Host computer. The role of USB Device is also called USB peripheral. For a communication link between two devices according to USB OTG, the appliance controlling the link is called the Host, while the other is called the Device or peripheral. USB OTG specification also defines: OTG A-device and OTG B-device, specifying which side supplies power to the link, and which initially is the Host. The OTG A-device is a power supplier, and an OTG B-device is a power consumer. In a default link configuration, the A-device acts as a USB Host with the B-device acting as a USB Device or USB peripheral.

The role of a device may be determined by the type of USB plug inserted to the USB receptacle in the device, such that the device with a Micro-A plug inserted becomes an OTG A-device, and the device with a Micro-B plug inserted becomes a B-device. The plug itself determines the state of the ID pin. The ID pin on a Micro-A plug is connected to the ground (GND). The ID pin on a Micro-B plug is floating or connected to ground by a large resistance. When the ID pin is latched to GND, the device becomes the A-device or the Host. When ID pin is latched to Float, the device becomes the B-device or the peripheral.

When replacing a cable with an OWC link between two devices, the aforementioned Host and peripheral distinguishing via the cable connection no longer work, since there is no differentiation between the connector hardware. It is also not practical to hardwire the ID-pin to a certain state (GND or Float), which will otherwise result in two different types of devices (e.g., an A device and a B device) and an interconnection may only be possible between an A device and a B device, which thus reduces the flexibility intended by a wireless link. Therefore, it is necessary to develop a more flexible approach to the assignment of Host/peripheral roles.

In view of the above, the present disclosure is directed to methods, apparatus, and systems for providing an auto-configuration mechanism for configuring an USB interface. More particularly, the goal of this invention is achieved by an optical front end (OFE) module as claimed in claim 1, by an OWC system as claimed in claim 12, by a method of an OFE module as claimed in claim 13, and by a computer program as claimed in claim 15.

In accordance with a first aspect of the invention an OFE module is provided. An OFE module for use in an optical wireless communication, OWC, system, the OFE module comprises an optical transmitter comprising at least a light source, wherein the optical transmitter is configured to transmit optical signals; an optical receiver comprising at least a light sensor, wherein the optical receiver is configured to receive optical signals; a control circuit configured to: connect to a USB On-The-Go, OTG, interface comprising a differential data path and an ID signal; route signals received on the differential data path to an input of the optical transmitter; route signals received on an output of the optical receiver to the differential data path; control a power-up sequence of the OFE module; wherein the power-up sequence defines that the OFE module is initialized by powering up the optical receiver first for detecting an optical test signal within an ID detection period; set the ID signal to GND and latch the ID signal when the optical test signal is received within the ID detection period; set the ID signal to Float and latch the ID signal when no optical test signal is received within the ID detection period.

The OFE module implements the conversion between electrical signals and optical signals for OWC communication. The optical transmitter is used to convert the electrical transmitting signals to output optical signals via the light source. The optical receiver is used to convert the received optical signals to output electrical signals via the light sensor for further signal processing. Preferably, the optical transmitter may further comprise a driver to regulate the power required for the light source. The optical receiver may further comprise an amplifier to condition the received signals by the light sensor to make the signals more suitable for further processing in the electrical circuits. The amplifier may be a transimpedance amplifier (TIA), which is a current to voltage converter implemented with one or more operational amplifiers. Preferably, the TIA is located close to the light sensor to amplify the signal with the least amount of noise.

To allow the OFE module to be integrated in or connected to an end device with a reduced system complexity of the end device, a control circuit is added to the OFE module to interface with a standard USB OTG interface of the end device. The control circuit is connected on the one side to the optical transmitter and the optical receiver in the OFE module, and on the other side to an interface of the OFE module towards the standard USB OTG interface of the end device.

To mimic the function of a Micro AB plug, the state of the ID signal is set by the control circuit based on the detection of an optical test signal within a predefined ID detection period. To achieve this goal, the control circuit controls a power-up sequence of the OFE module. The power-up sequence defines an order of how the individual blocks or components inside the OFE module are turned on sequentially. The OFE module is initialized by powering up the optical receiver first, with the rest of the circuit in sleep mode for power saving. Upon powering up, the optical receiver is configured to detect an optical test signal within an ID detection period. The optical test signal may comprise dummy data, and it may also be a kind of busy tone without carrying any data. Basically, it is used to notify the control circuit the presence of another device in the field of view.

When the optical test signal is received within the ID detection period, the control circuit sets the ID signal to GND and latches the ID signal. In that sense, the end device interfacing directly with the control circuit takes a Host role according to the USB OTG specification, while the other remote device sending the optical test signal takes on a peripheral role. After latching the ID signal, the rest of the OFE module will be powered up, and the standard USB OTG communication follows. The bi-direction communication on the USB OTG interface is routed by the control circuit to the optical transmitter and the optical receiver, respectively. For the USB interface of the end device, the OFE module then operates as a cable replacement.

In contrast, when no optical test signal is received within the ID detection period, the control circuit sets the ID signal to Float and latches the ID signal, indicating that the end device interfacing directly with the control circuit takes on a peripheral role. Therefore, if there is no other device sending the optical test signal, the peripheral role is set by default. Similar to the previous situation, after latching the ID signal, the rest of the OFE module will be powered up.

The ID detection period may be a predefined time window. It may also be reconfigured by a user of the end device via the USB interface. Furthermore, the duration of the ID detection period may also be related to an attribute of the end device, or a willingness of the end device to take a certain role. For example, if the end device prefers to act as a peripheral, the ID detection period may be decreased accordingly to reduce the chance of detecting an optical test signal. Furthermore, the duration may also be designed with a consideration on power efficiency or latency requirement.

In one option, the OFE module is fully integrated in an end device and connected to the USB OTG interface; wherein preferably, the end device is at least one of: a smartphone, a tablet, a computer, a remote controller, a smart TV, a display device, a Li-Fi USB hub, a storage device, a speaker, a home appliance, or another smart electronic device.

Preferably, the OFE module is fully integrated in the end device via the USB OTG interface. Thus, the control circuit of OFE module and the USB OTG interface may be permanently connected. Upon automatically configuring the ID signal pin of the USB interface, the end device may be assigned to a Host or peripheral role adaptively.

In another option, the OFE module is integrated in a standalone USB dongle device arranged to be connected to an end device via the USB OTG interface; wherein preferably, the end device is at least one of: a smartphone, a tablet, a computer, a remote controller, a smart TV, a display device, a Li-Fi USB hub, a storage device, a speaker, a home appliance, or another smart electronic device.

Assembled as a USB dongle or integrated in a USB dongle, the OFE module may comprise either a “Micro-A” or “Micro-B” plug (with ID pin arranged in a non-standard way), where the ID pin status is determined by the dongle in the same way as the fully integrated. And then upon automatic configuration of the ID signal on the plug, the connection with the end device proceeds according to the standard USB OTG protocol.

In one example, when no optical test signal is received within the ID detection period, the power-up sequence further defines that after latching the ID signal, the optical transmitter is powered up to send another optical test signal.

Without detecting the optical test signal, the control circuit latches the ID signal to Float, and the end device is assigned to a peripheral role. In order to pair with a remote device to establish the USB link, the optical transmitter is powered up to send another optical test signal to inform the remote device about the presence of a peripheral device. The optical test signal may be constructed in the same way for different devices.

If there are two remote end devices each comprising such an OFE module, with a same ID detection period, the one that powers up first will take the peripheral role, while the other one that powers up later will take the Host role. When the two devices are powered up around the same time, the one that has a shorter ID detection period will take the peripheral role. In practice, depending on the order of powering up and the selection of ID detection period, the Host/peripheral role may be set between two peer devices dynamically.

Preferably, the optical transmitter is configured to send the other optical test signal for a period shorter than the ID detection period.

In view of power efficiency, it is beneficial to reduce the time that the optical transmitter is transmitting dummy data or a busy tone, such that the period of sending the optical test signal may be shorter than the ID detection period.

In one setup, after the optical transmitter sends the other optical test signal, the optical receiver is further configured to detect an optical signal from a remote device within a connection waiting period, and the control circuit is further configured to: identify if the remote device is configured as a USB OTG Host based on the optical signal detected; carry out USB OTG communication when the remote device is identified as a USB OTG Host; and turn off the optical transmitter and reset the OFE module to restart the power-up sequence when no optical signal detected within the connection waiting period or the remote device is not identified as a Host.

After sending the other optical test signal, the OFE module is waiting for an optical signal representing a USB connection, such as a control signal for setting up the USB link, from a remote Host device, which is expected to be received within a connection waiting period. If there is such an optical signal received within the time window, the received optical signal will be routed to the data path on the USB interface and provided to the end device connected, the peripheral device. Upon verifying the optical signal is received from a remote Host device, the USB OTG link is established.

On the other hand, if the received optical signal is not recognized by the peripheral device, and it is not compliant with the USB OTG protocol, or if there is no optical signal received within the connection waiting period, it indicates that no USB link is established. The OFE module turns off the optical transmitter and resets the entire module to clear the latched ID signal. And then, the power-up sequence will be reinitialized. Beneficially, the control circuit is further configured to keep the OFE module in a sleep mode after the power-up sequence is restarted a predefined number of times or a predefined timeout period has lapsed.

It may also be the case that after several attempts to establish a USB link, such that after the OFE module goes through the cycle of first trying to detect an optical test signal and then, upon failure of detecting the optical test signal, sending the other optical test signal, there is still no USB link established. The OFE module may then enter sleep mode for power saving.

In a preferred setup, the control circuit is further configured to reset the OFE module and restart the power-up sequence when an on-going optical link via either the optical transmitter or the optical receiver is broken.

The optical wireless link may not be as stable as a cable connection, and the link is broken typically indicates that the two devices are no longer in line-of-sight. The on-going optical link may break due to a movement of an end device or due to an obstacle blocking the direct line-of-sight between the two devices. To allow the system to recover from such a situation, it is beneficial for the OFE module to restart the procedure described above for initializing a USB link.

In one example, a power supply to the OFE module is connected to the control circuit via a switch for control a power cycling of the OFE module.

It may also be an option to have an external control to have a hard reset or power cycling of the OFE module. In this option, the power supply to the OFE module is connected to the control circuit and controlled by a switch. The switch may be controlled either by a physical button or by a trigger signal derived from a user software in the end device.

Beneficially, the light source comprises at least one of a light-emitting diode, a super-luminescent light emitting diode, a laser diode, a vertical-cavity surface-emitting laser, VCSEL, and an Edge Emitting Laser Diode.

Preferably, the light sensor comprises at least one of a photodiode, a photo transistor, a photomultiplier, and an avalanche photodiode.

Considering that USB2.0 High-Speed operates at 480 Mbps data rate, it is desirable that the OFE supports at least the same data rate. Therefore, preferably a Laser Diode (LD) such a Vertical Cavity Surface Emitting Laser (VCSEL) or Edge Emitting Laser Diode (EELD) is used as the emitter in the optical transmitter, and an Avalanche Photo Diode (APD) is used as the detector in the optical receiver. This may relax the design constraints as compared to light-emitting diode implementations, on account of the higher bandwidth of such laser-based solutions.

In accordance with a second aspect of the invention an optical wireless communication, OWC, system is provided. An OWC system comprises: a first device that comprises a first OFE module according to the present invention or is connected to a second OFE module according to the present invention; and a remote second device that comprises a third OFE module according to the present invention or is connected to a fourth OFE module according to the present invention; wherein the first device and the remote second device are configured to carry out OWC communication.

Thus, in the current setup, the first device and the second device communicate to each other via a direct OWC link, instead of via an AP, forming a peer-to-peer OWC system.

In accordance with a third aspect of the invention a method of an OFE module is provided. A method carried out by an optical front end, OFE, module for use in an optical wireless communication, OWC, system, the method comprises the OFE module: transmitting optical signals by an optical transmitter; receiving optical signals by an optical receiver; connecting to a USB On-The-Go, OTG, interface comprising a differential data path and an ID signal; routing signals received on the differential data path to an input of the optical transmitter; routing signals received on an output of the optical receiver to the differential data path; controlling a power-up sequence; wherein the power-up sequence defines that the OFE module is initialized by powering up the optical receiver first for detecting an optical test signal within an ID detection period; setting the ID signal to GND, when the optical test signal is received within the ID detection period, and latching the ID signal; setting the ID signal to Float, when no optical test signal is received within the ID detection period, and latching the ID signal.

Beneficially, the method further comprises the OFE module: sending another optical test signal via the optical transmitter, when no optical test signal is received within the ID detection period; detecting an optical signal from a remote device by the optical receiver within a connection waiting period, after sending the other optical test signal; identifying if the remote device is configured as a USB OTG Host based on the optical signal detected; carrying out USB OTG communication when the remote device is identified as a USB OTG Host; and turning off the optical transmitter and resetting the OFE module to restart the power-up sequence when no optical signal detected within the connection waiting period or the remote device is not identified as a Host.

The invention may further be embodied in a computing program comprising code means which, when the program is executed by an OFE module comprising processing means, cause the processing means to perform the method of the OFE module as disclosed in the present invention.

### BRIEF DESCRIPTION OF THE DRAWINGS

In the drawings, like reference characters generally refer to the same parts throughout the different figures. Also, the drawings are not necessarily to scale, emphasis instead generally being placed upon illustrating the principles of the invention.

FIG. 1 illustrates an example block diagram of an optical front end integrated to an end device via a USB interface;

FIG. 2 demonstrates a basic block diagram of the OFE module comprised in an OWC system;

FIG. 3 illustrates two options of implementing the connection between the OFE module and an end device;

FIG. 4 illustrates an OWC system;

FIG. 5 shows a flow chart of an exemplary link initialization procedure;

FIG. 6 shows a timing diagram of two OFE modules carrying out the link initialization procedure;

FIG. 7 shows a flow chart of another exemplary link initialization procedure;

FIG. 8 shows an exemplary timing diagram of an OFE module carrying out the link initialization procedure;

FIG. 9 shows an exemplary timing diagram of an OFE module carrying out the link initialization procedure;

FIG. 10 shows an exemplary timing diagram of an OFE module carrying out the link initialization procedure;

FIG. 11 illustrates an exemplary block diagram of the OFE module; and

FIG. 12 shows a flow chart of a method of the OFE module.

### DETAILED DESCRIPTION OF EMBODIMENTS

The embodiments set forth below represent information to enable those skilled in the art to practice the embodiments and illustrate the best mode of practicing the embodiments. Upon reading the following description in light of the accompanying drawings, those skilled in the art will understand the concepts of the disclosure and will recognize applications of these concepts not particularly addressed herein. It should be understood that these concepts and applications fall within the scope of the disclosure.

A standard USB2.0 interface consists of 4 signals: VBUS, D+, D− and GND. The USB2.0 On-The-GO (OTG) supplement allows two USB devices directly communicate with each other via a cable (e.g., smartphone to smartphone, or smartphone to tablet). To enable this feature, a 5th pin is added to the interface—the ID pin. According to the OTG standard, an OTG product is a portable device that uses a single Micro-AB receptacle to operate as a USB host or as a USB Device/peripheral. An OTG device must always operate as a standard peripheral when connected to a standard USB host. OTG devices can also be attached to each other. The ID pin on a Micro-A plug shall be connected to the GND pin. The ID pin on a Micro-B plug is not connected or is connected to ground by a large resistance (>100 kΩ). An OTG device is able to detect whether a Micro-A or Micro-B plug is inserted by determining if the ID pin is connected to ground, thus configure itself as either a host or a peripheral.

An OTG device with the A-plug inserted is called the A-device and is responsible for powering the USB interface or the USB link when required and by default assumes itself the role of host. The OTG device with the B-plug inserted is called the B-device and by default assumes itself the role of peripheral. An OTG device with no plug inserted defaults to acting as a B-device. OTG devices attached either to a peripheral-only B-device or a host will have their role fixed by the cable since that is the only possible way to attach the cable.

Some typical OTG use cases are listed in Table 1 as below. These use cases have in common that the roles of host and peripheral are clearly defined by the matching interconnecting cable. Note that the female connector mounted on the host or device is called the receptacle, and the male connector attached to the cable is called the plug.

TABLE 1

| | Case 1: | Case 2: | Case 3: |
|---|---|---|---|
| | Phone to phone | Phone to TV | Phone to speaker |
| Use case type | OTG to OTG | OTG to host | OTG to peripheral-only |
| | (Symmetrical) | (Asymmetrical) | B-device |
| | | | (Asymmetrical) |
| A-device | Phone 1 (host) | TV (host) | Phone (host) |
| B-device | Phone 2 (peripheral) | Phone (peripheral) | Speaker (peripheral) |
| Receptacle on A | Micro AB | Standard Type A | Micro AB |
| Receptacle on B | Micro AB | Micro AB | Micro B |
| Plug inserted to A | Micro A plug | Standard Type A plug | Micro A plug |
| | (ID = GND) | | |
| Plug inserted to B | Micro B plug | Micro B plug | Micro B plug |
| | (ID = Float) | | |

When replacing a cable with a bi-directional OWC link between two devices by integrating OFE modules in these devices, the aforementioned host/peripheral differentiation via the cable connection cannot work anymore, because the OFE module is (quasi-)permanently attached to the USB interface and there is no cable. One option may be hard wiring the ID signal to GND or let it float inside the OFE module or the smartphone motherboard. However, this leads to two different types of hardware, and does not really solve the problem. For example, when both phones are hard-wired as host or as peripheral, the optical USB-LiFi communication link cannot be established. So hard wiring the ID point is not a practical solution. Furthermore, unlike a cable connection, the OWC link may be interrupted unexpectedly, such as due to a loss of line-of-sight. Therefore, a host-peripheral auto-configuration needs to be implemented for the OWC link in the phone.

When the OFE is assembled as a USB dongle and connected to the end device, the situation is similar to the previous scenario when the OFE is fully integrated in the end device. A hard wiring approach will result in two separate hardware or dongle versions (one with ID pin hardwired to GND and the other let it float), which will not only add cost and complexity to the system but also sacrifice user experience. Thus, the auto-configuration method disclosed in this specification also applies to the application of OFE extension to an end device via a USB dongle.

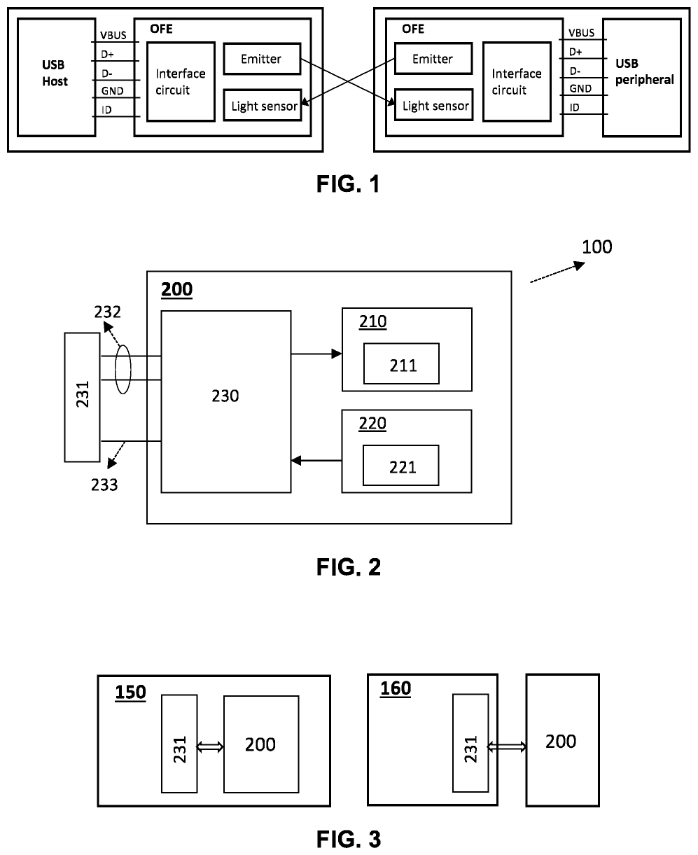

FIG. 1 illustrates an example block diagram of an optical front end integrated to an end device via a USB interface. Since USB2.0 High-Speed operates at 480 Mbps data rate, it is thus desirable that the OFE module supports a similar data rate or even higher data rate. Preferably, a Laser Diode (LD) such a Vertical Cavity Surface Emitting Laser (VCSEL) or Edge Emitting Laser Diode (EELD) is preferably used as the light source or emitter and, preferably, an Avalanche Photo Diode (APD) is used as the light sensor or light detector. Furthermore, an interface circuit is used to deal with various states of the USB bus. USB signals are transmitted using differential signaling on a twisted-pair data cable, labelled D+ and D−. The USB signal (D+, D−) is mapped to an optical signal via the transmitter and on the reverse direction the optical signal received by the light sensor is then mapped back to USB D+ and D−. This point-to-point link may also be called a “USB-LiFi” link in this specification.

FIG. 2 demonstrates a basic block diagram of the OFE module 200 comprised in an OWC system 100. The OFE module 200 comprises an optical transmitter 210, an optical receiver 220, and a control circuit 230.

The optical transmitter 210 and the optical receiver 220 comprise at least a light source 211 and a light sensor 221 respectively, which are configured to implement the conversion between electrical signals and optical signals. The optical transmitter 210 is used to convert the electrical transmitting signals to output optical signals via the light source 211. The optical receiver 220 is used to convert the received optical signals to output electrical signals via the light sensor 221 for further signal processing. The light source 211 comprises at least one of a light-emitting diode (LED), a super-luminescent light emitting diode (SLED), a laser diode (LD), a vertical-cavity surface-emitting laser (VCSEL), and an Edge Emitting Laser Diode (EELD), or an array of those. The light sensor 221 comprises at least one of a photodiode, a photo transistor, a photomultiplier, an avalanche photodiode, or an array of those. Beneficially, the optical transmitter 210 further comprises a driver to regulate the power required for the light source 211. Preferably, the optical receiver 220 further comprises an amplifier to condition the received signals by the light sensor 221, making the received signals suitable for further processing in the electrical circuits. In one example, the amplifier may be a transimpedance amplifier (TIA), which is a current to voltage converter implemented with one or more operational amplifiers. TIA may be located close to the receiving light sensor or photodiode 221 to amplify the signal with the least amount of noise.

The control circuit 230 is connected to the optical transmitter 210 and the optical receiver 220 inside the OFE module. The control circuit 230 is further configured to connect to a USB OTG interface 231 via at least a differential data path 232 and an ID signal 233 pin. Via the control circuit 230, signals received on the differential data path 232 are routed to an input of the optical transmitter 210, and signals received on an output of the optical receiver 220 are routed to the input on the differential data path 232. The control circuit 230 is further configured to take charge in the “discovery” procedure for pairing with another USB device.

FIG. 3 illustrates two options of implementing the connection between the OFE module 200 and an end device 150, 160. In the first option, the OFE module 200 is fully integrated in the end device 150. Thus, the OFE module is permanently connected to the USB OTG interface of the end device 150. Alternatively, the OFE module may be connected to the USB OTG interface via a switch, and thus the physical connection is physical but the OFE may also be electrically disconnected from the OTG interface. In the second option, the OFE module 200 is assembled as a standalone USB dongle or integrated in a USB dongle, and is connected to the end device 160 via the USB OTG interface.

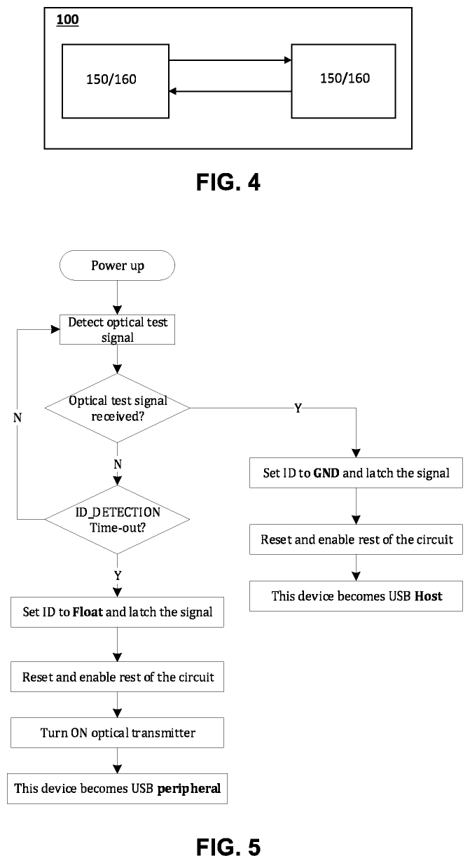

FIG. 4 illustrates an OWC system 100 comprising two remote devices 150, 160. The two devices 150, 160 are configured to make use of the OFE module 200 according to the present invention to establish an equivalent USB link, where the OWC link replaces the USB cable and provides more flexibility to the system.

FIG. 5 shows a flow chart of an exemplary link initialization procedure. The mechanism is based on a kind of “listen before talk” principle. By default, the OFE module will configure the phone as a USB peripheral, unless there is no other “peripheral” device in the field of view. This is realized by detection of an optical test signal immediately after power up (while keeping the rest of the OFE module disabled) for a certain ID DETECTION period. If an optical test signal is detected, this OFE module will set ID to GND and configure the OTG device as a USB host. If after ID_DETECTION period, no test signal is detected, this OTG device is configured to a USB peripheral. Therefore, the detection of a valid test signal is used as the equivalent of a “J-state” of the USB protocol that is transmitted by a USB peripheral. A USB peripheral has the 1.5 kΩ pullup resistor connected to the D+ link and exerts a J-state on the USB bus to indicate its presence.

It is noted that the ID detection result is latched and is not cleared by any other USB events once it is determined. With the current implementation, the OFE circuit is reset and enabled after the ID detection procedure (except the ID detection circuit) and normal USB operating procedure follows, such as USB reset and speed negotiation. To clear the ID detection result, the OFE module needs to go through a power cycle, i.e., switch off and then switch on the entire OFE module again, such a power cycle can be triggered by a user action such as pressing a physical button on the device (smartphone) or a trigger from a user software. Alternatively, the OFE module can be reset to clear the ID detection result via a reset interface (i.e., a pin) triggered by a user action such as pressing a physical button on the device (smartphone) or a trigger from user software.

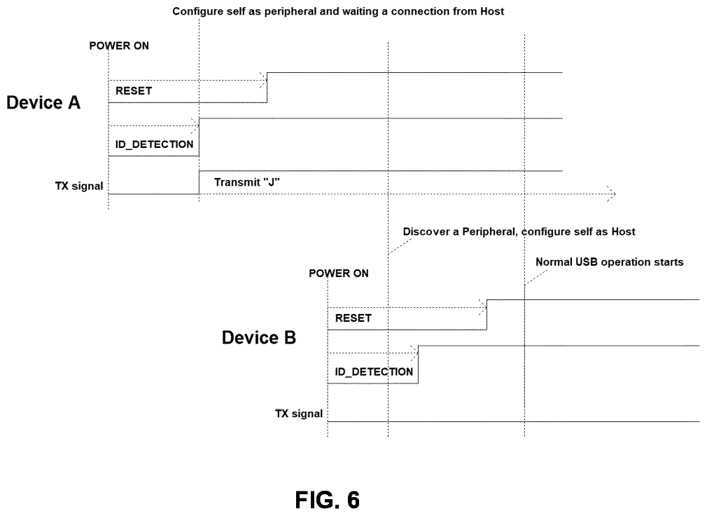

FIG. 6 shows a timing diagram of two OFE modules carrying out the link initialization procedure, which are in line of sight and establish a connection first time right. As shown in the figure, it is assumed that a first OFE module connected to or comprised in Device A powers up first and will emit the optical test signal, as indicated by “J” signal, while a second OFE module connected to or comprised Device B powers up later and will detect the “J” signal during the ID_DETECTION time window. Thus, Device B configures itself as Host. An active-low logic is drawn, just as an example, in FIG. 6 for RESET and ID_DETECTION signal. When the RESET signal is low, the RESET is active and holding the OFE circuit in reset (circuit disabled, except for the ID detection part), and when RESET goes high, it becomes an invalid signal and OFE normal operation starts. Similarly, when the ID_DETECTION signal is low, the device is performing ID detection by sensing the “J” signal and when the signal goes high, the detection stops.

OTG use cases with normal USB cable as presented in Table 1 are mapped to the situation with USB-LiFi interconnection in Table 2. The key difference results from the lack of a cable between two USB devices that defines the roles of the connected devices. Use case 1 and 2 are both feasible with the proposed method as illustrated in FIG. 5. However, use case 3 requires additional steps to make it work.

TABLE 2

| | Case 1: | Case 2: | Case 3: |
|---|---|---|---|
| | Phone to phone | Phone to TV | Phone to speaker |
| Use case type | OTG to OTG | OTG to host | OTG to peripheral-only B-device |
| | (Symmetrical) | (Asymmetrical) | (Asymmetrical) |
| A-device | Phone 1 (host) | TV (host) | Phone (host) |
| B-device | Phone 2 (peripheral) | Phone (peripheral) | Speaker (peripheral) |
| Receptacle on A | permanently connected | Standard Type A | permanently connected |
| Receptacle on B | permanently connected | permanently connected | Micro B |
| “Plug” inserted to | ID = GND, set by the | Standard Type A plug; | ID = Float or GND; |
| A | OFE control circuit | OFE module with Type A | Depending on if the phone is |
| | | plug is connected to the | power up first or not; If Speaker |
| | | TV. No ID pin; default to | powers up first, this is ok. In case |
| | | host. | Phone is the first, it defaults to |
| | | | Device; when it discovers no host |
| | | | can be connected it shall switch off |
| | | | transmitter then switched on and |
| | | | try again till a Device can be |
| | | | discovered (this happens when the |
| | | | speaker is powered on). |
| “Plug” inserted to | ID = Float, set by the | ID = Float, set by the OFE | Micro B plug |
| B | OFE control circuit; | control circuit; | |
| | this is the one powered | Can powerup later since | |
| | up first. | A-device is already | |
| | | configured to host (does | |
| | | not emit IR before a | |
| | | connection is made). | |

In use case 1, two OTG smartphones are connected via an OWC link. The two OFEs modules are powered separately by the two phones. The power up procedure may be implemented via the power management circuit of the smartphone, which provides supply power to the OFE module (VBUS and/or other power line) after a user action such as pressing the power button on the phone or an event from an application software indicating an attempt to access the USB interface. Alternatively, a separate power-up signal line (pin) may be used to trigger the power-up procedure. Since in practice there will always be some difference in the power up sequence (i.e., in the exact timing) of the two remote OFE modules, the mechanism for determination of host and peripheral role will work.

Use case 2 refers to a USB connection between the USB-LiFi phone and a host (a PC, TV, etc.). In this case, the OFE module attached to the TV is preferably in a form factor of a USB dongle with a standard Type A plug and plugged to a standard Type A receptable on the TV. Since the TV with Type A receptable can only act as a host, the OFE module inside the dongle will be “hardwired” as host OFE in this example. In fact, there is no ID pin in a standard Type A plug, and the TV has a fixed role as host. Since the host OFE does not transmit a signal after power up, the method in FIG. 5 will automatically work regardless of the powerup sequence between the TV and the phone. The TV OFE module always “waits” for an optical signal from the phone to start the USB link.

In use case 3, the role of a USB device will be assigned depending on the power up sequence. Here the phone needs to connect to a peripheral-only device (e.g., a speaker). The speaker may have a USB OFE dongle connected. The phone has to assume the host role, and the method shown in FIG. 5 only works when the speaker is powered up earlier than the phone.

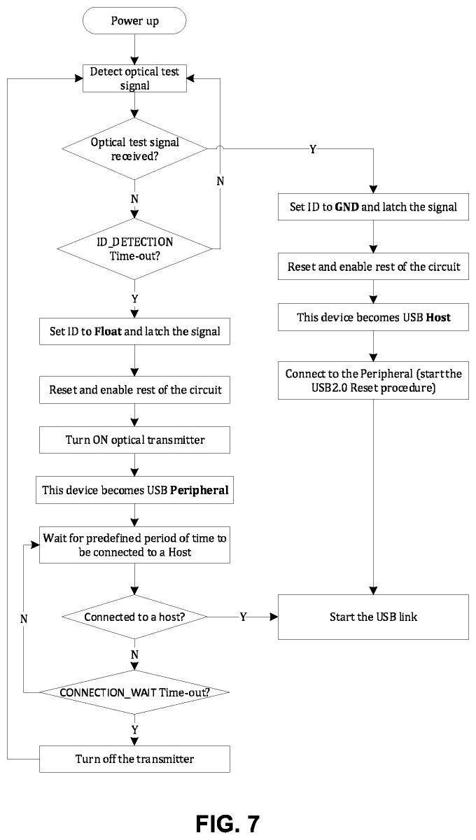

To deal with use case 3, a further developed example is shown in FIG. 7. A second timeout CONNECTION_WAIT is defined, or the connection waiting period. In case the phone is powered up first and does not detect an optical test signal within the ID_DETECTION time window, it assumes the role of peripheral (which is a wrong assumption in this use case). The phone then waits for CONNECTION_WAIT time and finds out there was no host it can connect to. Then after this CONNECTION_WAIT timeout, the OFE module turns off the transmitter and the “discovery” procedure restarts. This process may continue until the speaker is powered up and takes a role of peripheral and then the phone will act as host.

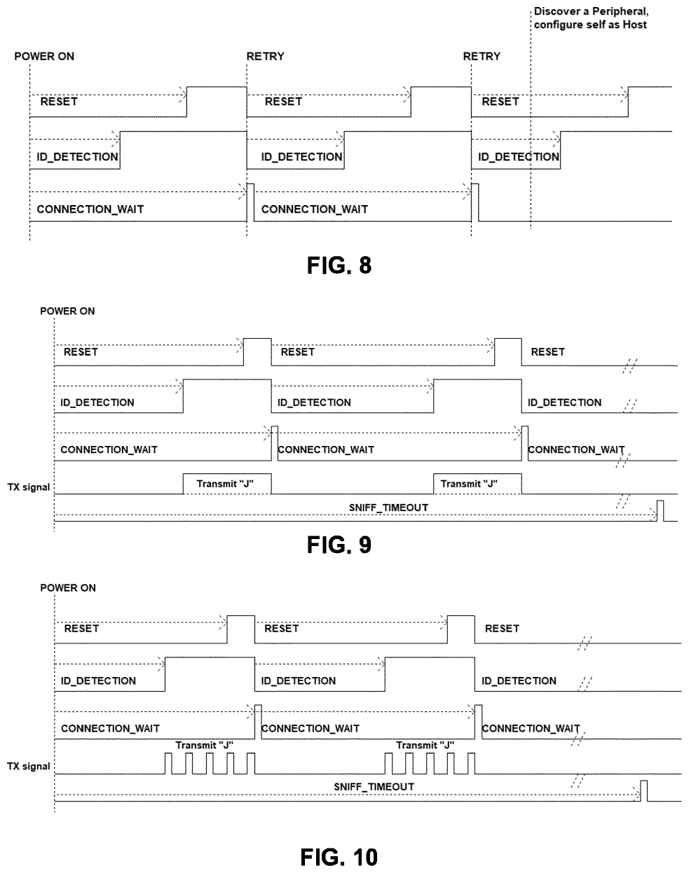

FIG. 8 shows a timing diagram according to the further developed method of FIG. 7. A device initially configures itself as a peripheral and fails to find a host. After the CONNECTION_WAIT timeout or the connection waiting period, it retries the procedure till a peripheral is discovered. The CONNECTION_WAIT may be implemented with a timer or delay circuit which generates a pulse when the predetermined time period is reached. The timeout pulse of CONNECTION_WAIT timer resets the OFE module RESET and ID_DETECTION signal and a new detection cycle starts all over again.

So far it has been assumed that the two OFE modules, after powering up, are in line-of-sight with each other. However, this may not always be the case. For example, it may be the situation that one device is powered up when being out of sight of the other device, and then moves into sight of that device. It means that upon failure to detect an optical test signal at the start, the OFE module needs to sniff whether another device comes within reach. It is desirable to reduce power dissipation of the OFE module during the waiting period. As the end device connected to the OFE module is set as a peripheral, the OFE module needs to emit another test signal, such as a busy tone or a packet with dummy data. Preferably, the duration of sending the test signal is shorter than the ID_DETECTION Time-out duration, otherwise it may not be detected when another device is powering up. So, we may define here short bursts of J-state-equivalent signals with a repetition rate higher than the inverse of the ID_DETECTION Time-out duration (for fastest establishment of a link) or at least with a repetition rate that is substantially different from the inverse of the ID_DETECTION Time-out duration (in which case it may take a few listening cycles before an optical signal is detected). This procedure may repeat until another device enters in the line-of-sight. However, it may also be a situation where there is no other pairing device present within the field of view. To prevent needless/endless operation of the OFE module a SNIFF timeout is defined to abort the procedure to prevent excess power dissipation.

To further reduce power dissipation, another exemplary timing diagram of an OFE module carrying out the link initialization procedure is shown in FIG. 9. After several retries, the device decides to stop the “discovery” procedure and enters a low power mode. To restart the procedure, a user may take an action such as by pressing a physical button or a trigger from application software. Preferably, the time duration for transmitting the “J” is significantly shorter than the interval between two successive ID detection period, as shown in FIG. 9, for power saving.

It may also be an option to split the optical test signal or signal “J” into a group of short pulses to further reduce the power consumption, as illustrated in FIG. 10.

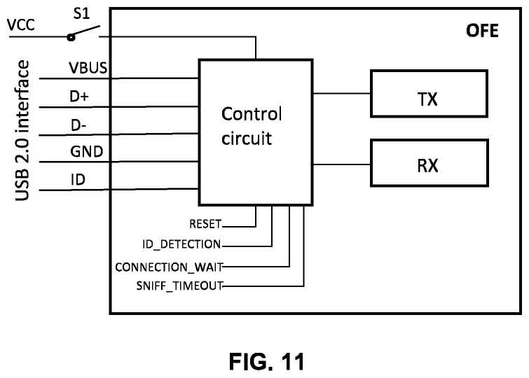

FIG. 11 illustrates another exemplary block diagram of the OFE module. Switch S1 may be for power cycling. S1 may be controlled by a physical switch on the device or by a trigger signal from user software. Timing constants used in the method may be configurable via inputs to the control circuit, which allows a user to further regulate the detection procedure by controlling such timing constants. The timing constants may be derived based on a tradeoff between power consumption and detection speed. This applies not only to the wait-time or time-out settings, but also to power management with respect to other blocks in the module. Such parameters (not limited to those listed in FIG. 11) can be made user configurable.

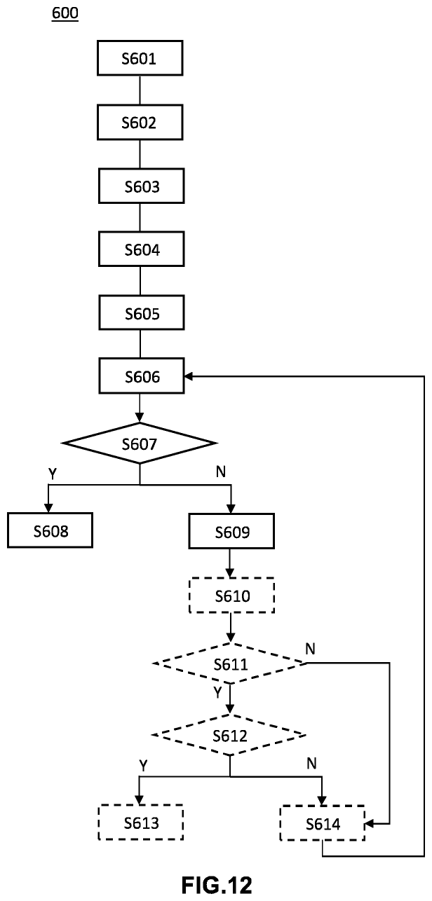

FIG. 12 shows a flow chart of a method 600 of the OFE module 200. A method 600 carried out by an optical front end, OFE, module 200 for use in an optical wireless communication, OWC, system 100, the method comprising the OFE module 200: in step S601, transmitting optical signals by an optical transmitter 210; in step S602, receiving optical signals by an optical receiver 220; in step S603, connecting to a USB On-The-Go, OTG, interface 231 comprising a differential data path 232 and an ID signal 233; routing, in step S604, signals received on the differential data path 232 to an input of the optical transmitter 210; routing, in step S605, signals received on an output of the optical receiver 220 to the differential data path 232; and controlling, in step S606 a power-up sequence; wherein the power-up sequence defines that the OFE module 200 is initialized by powering up the optical receiver 220 first for detecting an optical test signal within an ID detection period in step S607; and in step S608, setting the ID signal 233 to GND, when the optical test signal is received within the ID detection period, and latching the ID signal 233; and in step S609, setting the ID signal 233 to Float, when no optical test signal is received within the ID detection period, and latching the ID signal 233.

Optionally, the method 600 may further comprises the OFE module 200: sending in step S610 another optical test signal via the optical transmitter 210, when no optical test signal is received within the ID detection period; detecting in step S611 an optical signal from a remote device 150, 160 by the optical receiver 220 within a connection waiting period, after sending the other optical test signal; identifying in step S612 if the remote device 150, 160 is configured as a USB OTG Host based on the optical signal detected; carrying out in step S613 USB OTG communication when the remote device 150, 160 is identified as a USB OTG Host; and turning off in step S614 the optical transmitter 210 and resetting the OFE module 200 to restart the power-up sequence when no optical signal detected within the connection waiting period or the remote device 150, 160 is not identified as a Host.

The methods according to the invention may be implemented on a computer as a computer implemented method, or in dedicated hardware, or in a combination of both.

Executable code for a method according to the invention may be stored on computer/machine readable storage means. Examples of computer/machine readable storage means include non-volatile memory devices, optical storage medium/devices, solid-state media, integrated circuits, servers, etc. Preferably, the computer program product comprises non-transitory program code means stored on a computer readable medium for performing a method according to the invention when said program product is executed on a computer.

Methods, systems, and computer-readable media (transitory and non-transitory) may also be provided to implement selected aspects of the above-described embodiments.

1. An optical front end, OFE, module for use in an optical wireless communication, OWC, system, the OFE module comprising:
an optical transmitter comprising a light source, wherein the optical transmitter is configured to transmit optical signals;
an optical receiver comprising a light sensor, wherein the optical receiver is configured to receive optical signals;
a control circuit configured to:
connect to a USB On-The-Go, OTG, interface comprising a differential data path and an ID signal;
route signals received on the differential data path to an input of the optical transmitter;
route signals received on an output of the optical receiver to the differential data path;
control a power-up sequence of the OFE module; wherein the power-up sequence defines that the OFE module is initialized by powering up the optical receiver first for detecting an optical test signal within an ID detection period;
set the ID signal to GND and latch the ID signal when the optical test signal is received within the ID detection period; and
set the ID signal to Float and latch the ID signal when no optical test signal is received within the ID detection period.

2. The OFE module according to claim 1, wherein the OFE module is fully integrated in an end device and connected to the USB OTG interface.

3. The OFE module according to claim 1, wherein the OFE module is integrated in a standalone USB dongle device arranged to be connected to an end device via the USB OTG interface.

4. The OFE module according to claim 1, wherein when no optical test signal is received within the ID detection period, the power-up sequence further defines that after latching the ID signal, the optical transmitter is powered up to send another optical test signal.

5. The OFE module according to claim 4, wherein the optical transmitter is configured to send the other optical test signal for a period shorter than the ID detection period.

6. The OFE module according to claim 4, wherein after the optical transmitter sends the other optical test signal, the optical receiver is further configured to detect an optical signal from a remote device within a connection waiting period, and the control circuit is further configured to:
identify if the remote device is configured as a USB OTG Host based on the optical signal detected;
carry out USB OTG communication when the remote device is identified as a USB OTG Host; and
turn off the optical transmitter and reset the OFE module to restart the power-up sequence when no optical signal detected within the connection waiting period or the remote device is not identified as a Host.

7. The OFE module according to claim 6, wherein the control circuit is further configured to keep the OFE module in a sleep mode after the power-up sequence is restarted a predefined number of times or a predefined timeout period has lapsed.

8. The OFE module according to claim 1, wherein the control circuit is further configured to reset the OFE module and restart the power-up sequence when an on-going optical link via either the optical transmitter or the optical receiver is broken.

9. The OFE module according to claim 1, wherein a power supply to the OFE module is connected to the control circuit via a switch S1 for control a power cycling of the OFE module.

10. The OFE module according to claim 1, wherein the light source comprises one of a light-emitting diode, a super-luminescent light emitting diode, a laser diode, a vertical-cavity surface-emitting laser, and an Edge Emitting Laser Diode.

11. The OFE module according to claim 1, wherein the light sensor comprises one of a photodiode, a photo transistor, a photomultiplier, and an avalanche photodiode.

12. An optical wireless communication, OWC, system comprising:
a first device comprising an OFE module according to claim 2; and
a remote device comprising an OFE module according to claim 2;
wherein the first device and the remote second device are configured to carry out OWC communication.

13. A method carried out by an optical front end, OFE, module for use in an optical wireless communication, OWC, system, the method comprising the OFE module:
transmitting optical signals by an optical transmitter;
receiving optical signals by an optical receiver;
connecting to a USB On-The-Go, OTG, interface comprising a differential data path and an ID signal;
routing signals received on the differential data path to an input of the optical transmitter;
routing signals received on an output of the optical receiver to the differential data path;
controlling a power-up sequence; wherein the power-up sequence defines that the OFE module is initialized by powering up the optical receiver first for detecting an optical test signal within an ID detection period;
setting the ID signal to GND, when the optical test signal is received within the ID detection period, and latching the ID signal;
setting the ID signal to Float, when no optical test signal is received within the ID detection period, and latching the ID signal.

14. The method of claim 13, wherein the method further comprises the OFE module:
sending another optical test signal via the optical transmitter, when no optical test signal is received within the ID detection period;
detecting an optical signal from a remote device by the optical receiver within a connection waiting period, after sending the other optical test signal;
identifying if the remote device is configured as a USB OTG Host based on the optical signal detected;
carrying out USB OTG communication when the remote device is identified as a USB OTG Host; and
turning off the optical transmitter and resetting the OFE module to restart the power-up sequence when no optical signal detected within the connection waiting period or the remote device is not identified as a Host.

15. A non-transitory computer readable medium comprising instructions which, when the instructions are executed by an OFE module comprising processor, cause the processor to perform the method of claim 13.
